(19) United States
(12) Patent Application Publication
(10) Pub. No.: US 2011/0026525 A1
(43) Pub. Date: Feb. 3, 2011

(54) Ethernet Switch and System

(76) Inventor: Ziqiang He, Danville, CA (US)

Correspondence Address: ZIQIANG HE, 729 SENCA CT., DANVILLE, CA, 94526, US

(21) Appl. No.: 12/848,218

(22) Filed: Aug. 1, 2010

Related U.S. Application Data
(60) Provisional application No. 61/230,749, filed on Aug. 3, 2009.
(60) Provisional application No. 61/248,436, filed on Oct. 3, 2009.

(51) Int. Cl. H04L 12/56

(52) U.S. Cl. 370/392

(57) ABSTRACT

An Ethernet switch includes a plurality of network ports, wherein visibility of data packets traffic is configured by loading port-mirroring related configuration data from a configuration memory device into the Ethernet switch upon power-on reset. As a result, no manual configuration by a user is required, and the hardware cost of the Ethernet switch is reduced. The Ethernet switch is further configured to enable pass-through of Power over Ethernet (PoE) inline power between two selected network ports. A USB connector is further included and adapted for the Ethernet switch to receive input power from a USB port of a USB host device and for the Ethernet switch to send and receive data packets to and from the USB host device.

### CROSS-REFERENCE TO RELATED APPLICATIONS

This application claims priority from Provisional Application No. 61/230,749, filed Aug. 3, 2009, and Provisional Application No. 61/248,436, filed Oct. 3, 2009.

### FIELD OF THE INVENTION

This invention relates generally to communication networks. More particularly, this invention is related to a new and improved Ethernet switch capable of providing data packet traffic visibility.

### BACKGROUND OF THE INVENTION

Ethernet switches are networking apparatus used in a Local Area Network (LAN) to connect computers and other related network devices for facilitating data packet communications among such connected computers and other related network devices.

FIG. 1 illustrates a typical LAN 100. A first Ethernet switch 105 includes a set of network ports, each network port is connectable to a network device such as a printer 140, a server 145, a Voice over IP Private Branch Exchange (VoIP PBX) 150 or a wireless access point (AP) 155; a second Ethernet switch 110 includes a set of network ports, each network port is connectable to a network device such as a computer 120 or an IP phone 115. The two Ethernet switches 105 and 110 are interconnected by a network cable 160 such as a Category 5e (Cat5e) cable. As such, any connected network devices as shown in FIG. 1 can send and receive data packets to and from other network device(s). For example, the computer 120 can send data packets of a print job to the network printer 140 via the second Ethernet switch 110 and the first Ethernet switch 105. Specifically, when the second Ethernet switch 110 receives the data packet sent from the computer 120, it forwards the data packet to the first Ethernet switch 105 over the network cable 160 based on the destination Media Access Control (MAC) address of the network print 140, which is embedded in the received data packet; the first Ethernet switch 110 will then forward the date packet to the corresponding network port connecting the network printer 140 based on the destination MAC address of the data packet. A MAC address is a unique identifier of 48-bit binary sequence assigned to a network device, which is adopted by the Institute of Electrical and Electronics Engineers (IEEE) for several different networking technologies including Ethernet, ATM, Fiber Channel and etc. An Ethernet data packet includes a source MAC address and a destination MAC address in which the source MAC address represents the network device that transmits the data packet and the destination MAC address represents the network device that is to receive the data packet. An Ethernet switch forwards received data packets based on a data packet forwarding table which is established by a self-learning procedure based on the source and destination MAC addresses of received data packets as well as which network ports the respective data packets are received.

A main benefit of using Ethernet switches for providing network communications is that an Ethernet switch can provide point-to-point logical connections very effectively to avoid transmission “collisions” when multiple pairs of network devices are sending and receiving data packets at the same time. For instance, under the operations of the first Ethernet switch 105 and the second Ethernet switch 110, the computer 120 can send and receive data packets to and from the network printer 140 while the IP phone 115 is sending and receiving data packets to and from the VoIP PBX 150.

Nevertheless, there are still technical and operational aspects related to an Ethernet switch that needs to be improved, as explained in the following with reference to FIG. 1:
1) Traffic visibility. Traffic visibility is the capability of viewing or monitoring incoming and/or outgoing packets associated with a network port (referred to as target port) on an Ethernet switch from another network port (referred to as monitor port) by a computer connected to the monitor port. Traffic visibility is required for many applications such as VoIP phone call recording and network traffic analysis. For example, in FIG. 1, the computer 120 may run a VoIP phone call recording program to record the phone conversations of the IP phone 115, which requires that the computer receive a copy of both incoming and outgoing packets of the network port connected to the IP phone 115. Technically, such a traffic visibility can be achieved by implementing the port mirroring function in an Ethernet switch by which a copy of data packets of the target port is forwarded to the monitor port. However, an unmanaged Ethernet switch that is available today on the market is not capable of providing such traffic visibility or port mirroring function. An unmanaged Ethernet switch is an Ethernet switch that is not user configurable, but it is usually of low cost and ease to use. On the other hand, port mirroring is usually found with a managed Ethernet switch, but the port mirroring functionality is always a software feature disabled by default in the managed Ethernet switch; a user has to configure the Ethernet switch through its management user interface to enable the port mirroring functionality. Such a manual configuration process obviously adds complexity or difficulty in using the Ethernet switch. For example, a user has to spend time in learning how to configure the Ethernet switch; in many situations a user may have to get approval from the change control department in a company before the user is allowed to change configurations on an Ethernet switch. Furthermore, a managed Ethernet switch is usually implemented with a CPU-based control module running management/configuration software, which makes it more expensive to build than an unmanaged Ethernet switch. As such, an unmanaged Ethernet switch which can provide traffic visibility without losing the benefits of low cost and ease of use is extremely desirable.
2) Power over Ethernet (PoE) Pass-Through. Power over Ethernet refers to the Ethernet technology specified in the IEEE 802.3af standard for transmitting both power and data packets from an Ethernet switch to an end network device on a shared network cable such as a Category 5e (Cat5e) cable. For example, the first switch 105 can be a PoE enabled Ethernet switch which supplies PoE inline power to the wireless AP 155 by using a network cable connecting the first Ethernet switch 105 and the AP 155; the same network cable also transmits data packets between the first Ethernet switch 105 and the wireless AP 155. As such, the wireless AP benefits from the PoE technology that it is powered directly from the first Ethernet switch 105 and therefore it does not have to receive power from an additional electrical outlet, which may not be within a reachable distance. However, a problem arises when the first Ethernet switch 105 is intended be used to supply PoE inline power to power the IP phone 115 as the second Ethernet switch 110 is deployed in between the first Ethernet switch 105 and the IP phone 115 and therefore would prevent the IP phone 115 from receiving the PoE inline power delivered from the first switch 105. As such, it is desirable that the second Ethernet 110 can pass through the PoE inline power presented on the network cable 160 to the IP phone 115.
3) Availability of external power supply sources. In FIG. 1, the second Ethernet switch 110 is shown with a DC power jack 135 that is being connected with an AC/DC adapter 130 that is further connectable to an AC electrical outlet by the AC power plug 125. Although supplying power to the second Ethernet switch 110 from an AC electrical outlet as shown in FIG. 1 is a common practice, it is not unusual that often times an AC outlet within reachable distances from the second Ethernet switch 110 is not conveniently available. As the second Ethernet switch 110 may be placed in the vicinity of the computer 120, it is therefore very desirable that the second Ethernet switch 110 can be powered from a power supply source available from the computer 120, e.g., the +5V power output from a USB port of the computer 120.

Therefore, what is needed is an improved Ethernet switch such that the above discussed problems and limitations can be resolved.

### BRIEF DESCRIPTION OF THE DRAWINGS

The foregoing and other features, aspects and advantages of the invention will become more apparent from the following detailed description when read in conjunction with the following drawings, in which,

FIG. 1 is a block diagram of a local area network (LAN) in which two interconnected Ethernet switches are used to provide network connections to multiple network devices.

FIG. 2 is a block diagram of an Ethernet switch in accordance with an embodiment of the invention.

FIG. 3 is a more detailed circuit diagram showing a dual-transformer module operative for PoE inline power pass-through between two network ports according to the invention.

FIG. 4 is a block diagram of an embodiment of the invention in which a USB connector is implemented for an Ethernet switch to receive DC power supply from a USB host device and to send and receive data packets to and from the USB host device.

### DETAILED DESCRIPTION OF THE INVENTION

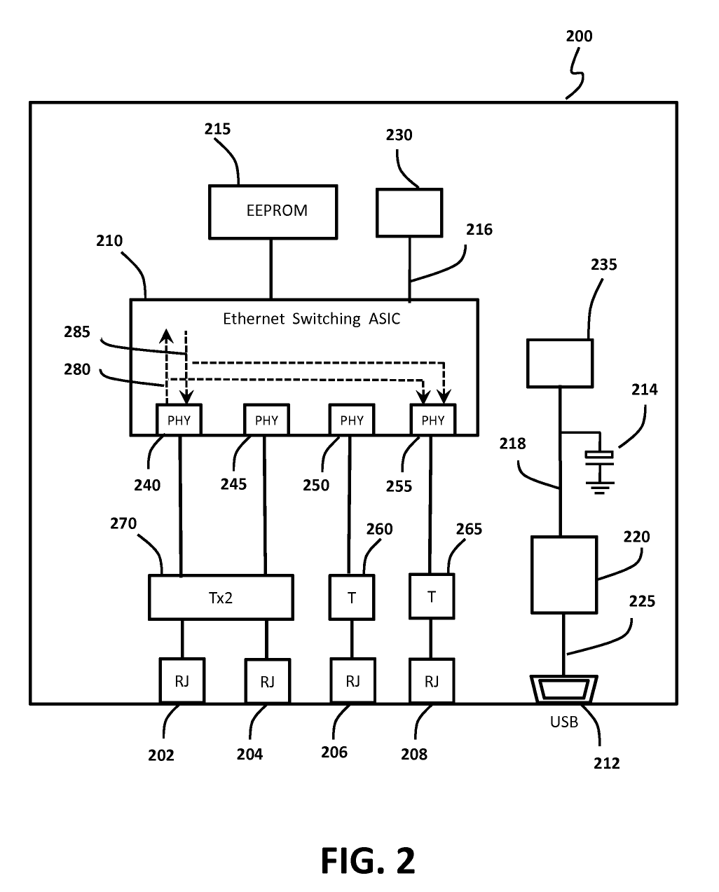

FIG. 2 is a block diagram of an Ethernet switch 200 for providing port-mirroring functionality without manual configuration by a user in accordance with an embodiment of the invention. The Ethernet switch 200 is implemented with an Ethernet switching Application Specific Integrated Circuit (ASIC) 210 which is integrated with multiple Ethernet physical layer transceivers (PHYs) that are referred to as PHY ports 240, 245, 250 and 250 hereinafter. Specifically, a single-chip 5-Port 10/100/1000 Switch Controller, RTL8366SB, from Realtek Semiconductor Corp., can be used as the Ethernet switching ASIC 210. The Ethernet switching ASIC 210 operates in such a way that it forwards a data packet received on any PHY port 240, 245, 250 or 250 to another one or more PHY ports based on the destination MAC address of the received data packet. A received packet can be forwarded to more than one PHY ports if the data packet is a broadcast packet according to the Ethernet IEEE 802.3 standard.

According to the invention, an Electrically Erasable Programmable Read-Only Memory (EEPROM) 215 is provided and connected with the Ethernet switching ASIC 210. The EEPROM 215 stores configuration data that is loaded into the Ethernet switching ASIC 210 upon power-on reset to configure the operations for the Ethernet switching ASIC 210. The power-on reset is an event related to the operations of the Ethernet switching ASIC 210 during which the Ethernet switching ASIC 210 is held in a reset condition by a power-on reset input signal 216 during its power up process. The power-on reset signal 216 is generated by a power on reset signal generator 230 and is applied to the Ethernet switching ASIC 210. The power on reset signal generator 230 ensures that the power-on reset signal is kept asserted until the on-board power voltage rails become stable and the internal circuitry of the Ethernet switching ASIC 200 becomes ready to operate normally. According to the invention, the Ethernet switching ASIC 210 is configured in such a way after being loaded into the configuration data from the EEPROM 215 that it mirrors both incoming data packet traffic 280 and outgoing packet traffic 285 of the PHY port 240 (target port) to the PHY port 255 (monitor port). The incoming data packet traffic 280 refers to ingress data packets received by the PHY port 240 which are sent from an externally connected network device; the outgoing data packet traffic 285 refers to egress data packets forwarded to the PHY port 240 from other PHY ports within the Ethernet switching ASIC 210 which are to be transmitted to the externally connected network device. In such a way, the traffic visibility on the PHY port 240 is achieved because the PHY port 255 receives a copy of both incoming (ingress) packets and outgoing (egress) data packets of the PHY port 240. As such, a user does not need to perform any configuration manually because the port-mirroring related configuration data is stored in the EEPROM 215 and is loaded into the Ethernet switching ASIC 210 automatically upon power-on reset. Furthermore, because no CPU module with supporting software is required, the overall cost of implementing the Ethernet switch 200 is substantially reduced.

As shown in FIG. 2, it can be noted that port over-subscription may occur to the monitor port 255 when the aggregated full duplex traffic throughput of the target port 240 exceeds the maximum outgoing traffic throughput of the monitor port. For example, if both the target and monitor ports operate at gigabit Ethernet speed, i.e., 1000 Mbps, the maximum aggregated traffic throughput of the target port 240 can be as high as 2000 Mbps, twice as much as the outgoing traffic throughput of the monitor port 255. When port over-subscription occurs, the Ethernet switch 200 will be forced to drop the mirrored packets from the target port 240. Therefore, in another embodiment of the invention, a copy of incoming data packet traffic 280 of the PHY port 240 is forwarded to the PHY port 250 and a copy of the outgoing data packet traffic 285 of the PHY port 240 is forwarded to the PHY port 255. As can be appreciated by a person skilled in the art, mirroring a full duplex traffic of data packets of the PHY port 240 to two separate PHY ports 250 and 255 respectively can prevent mirrored packets from being dropped due to port over-subscription.

As shown in FIG. 2, the PHY ports 240, 245, 250 and 255 are AC coupled to the corresponding RJ45 jacks 202, 204, 206 and 208 via respective transformer modules 270, 260 and 265. A RJ45 jack is an industry standard 8-pin connector connectable with an 8-wire network cable such as a Cat5e cable. The transformer 270 module is a dual-transformer module further adapted for providing PoE inline power pass-through function, which will be further illustrated later. Each transformer module is operative in passing full-duplex Ethernet data packet signals while providing adequate DC isolation for electrical safety purpose as specified in the IEEE 802.3 standard.

The RJ45 jacks 202, 204, 206 and 208 are the network ports of the Ethernet switch 200.

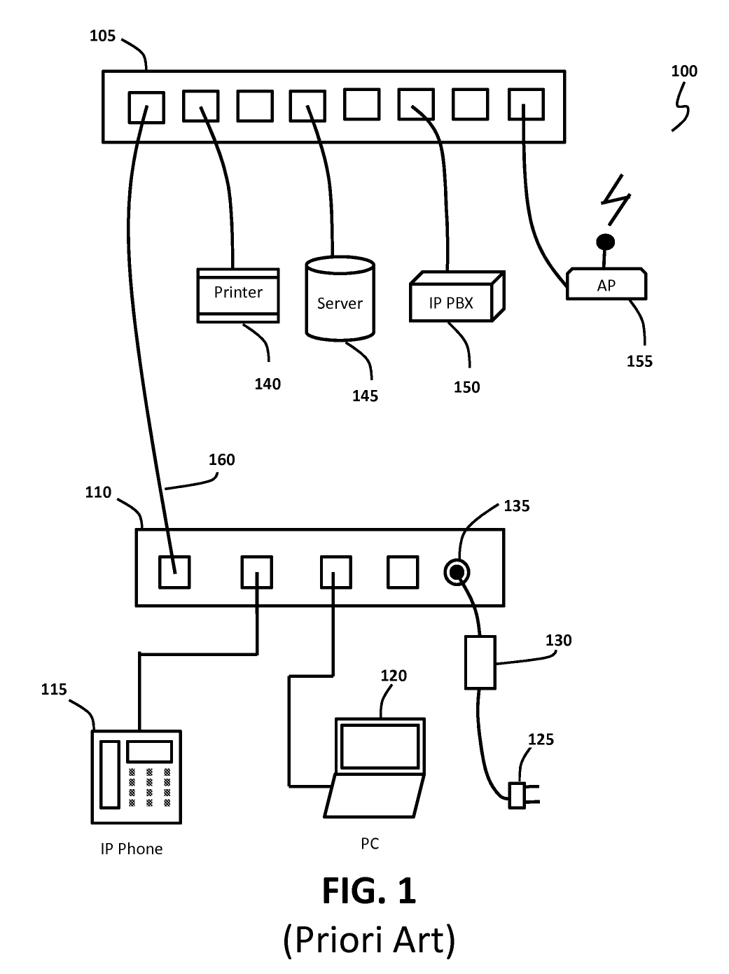

According to the invention, the Ethernet switch 200 is provided with a USB connector 212 so that it is connectable to a USB host port of a USB host device such as the computer 120 in FIG. 1 in order to receive DC power supply from the USB host port. The USB connector 212 consists of four conduct pins including a +5V power pin, a ground pin and two data pins for passing differential signaling of USB data packets. An obvious benefit of doing so is that the Ethernet switch 200 does not have to be powered by receiving power from an AC outlet, which may not be located within a conveniently reachable distance. Because the Ethernet switch 200 is able to be powered by connecting to a live or active USB host port, a high magnitude of inrush current could occur as a result of the power supply source of the active USB host port charging to the bulk capacitor 214 of the power receiving circuit of the Ethernet switch 200, which would cause various adverse impacts to the USB host port as well as the Ethernet switch 200. For example, an otherwise unsuppressed inrush current may force the USB host port to turn off the 5V power output, and it may even be destructive to the associated interfacing circuit of the USB host port. As such, an inrush current controller 220 (also called hot-swap controller) is implemented for the power receiving circuit of the Ethernet switch 200 to limit or suppress the magnitude of inrush current to an appropriate level and thus to protect the USB host port from being damaged or any mal-functioning. Specifically, a USB Power Switch and Over-Current Protection IC, LM3525, from National Semiconductor is used for implementing the inrush current controller 220. The inrush current controller 220 receives input DC power supply 225 and sends its output DC power 218 to a DC/DC converter 235 which further produces various on-board voltage rails necessary for powering the Ethernet switching ASIC 210 as well as other on board active electronics components.

Furthermore, the Ethernet switch 200 according to the invention is implemented in such a way that its maximum power consumption is limited to less than the maximum output power available from a USB host port. For example, a USB host port in compliance with USB 2.0 specification can output a maximum current of 0.5 A at 5V, or a maximum power output of 2.5 watts. As such, the maximum power consumption of the Ethernet switch 200 that is operative by receiving power from a USB host port in compliance with USB 2.0 specification is limited to less than 2.5 watts. This requirement can be met by limiting the number of network ports to what the maximum output power from the USB host port can support. Preferably, the number of network ports of Ethernet switch 200 is limited to less than 5.

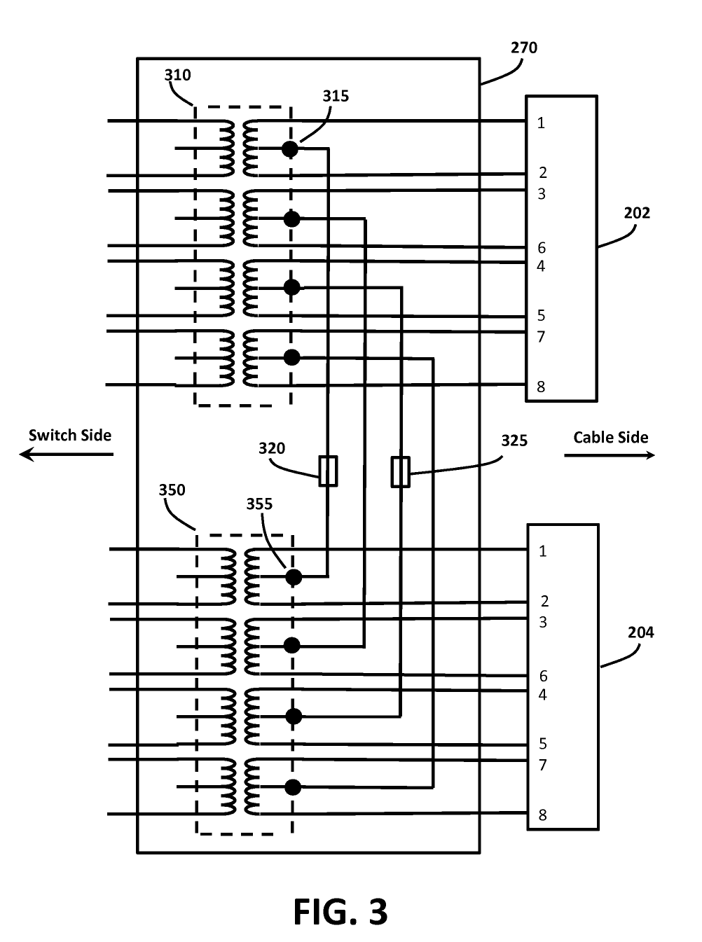

FIG. 3 is a more detailed circuit diagram showing the dual-transformer module 270 in FIG. 2 which is configured to enable the pass through of PoE inline power between two network ports, i.e., RJ45 jacks 202 and 204, according to the invention. As shown in FIG. 3, the dual-transformer module 270 includes two Ethernet signal transformers 310 and 350; the 8 cable-side signal taps of the transformer 310 are connected to the corresponding 8 pins of the RJ45 jack 202 with pins numbered in the order of 1, 2, 3, 6, 4, 5, 7 and 8, and the 8 switch-side signal taps of the transformer 310 are connected to the corresponding PHY port 240 of the Ethernet switching ASIC 210 in FIG. 2. In the same way, the 8 cable-side signal taps of the transformer 350 are connected to the corresponding 8 pins of the RJ45 jack 204, and the 8 switch-side signal taps of the transformer 350 are connected to the corresponding PHY port 245 of the Ethernet switching ASIC 210. The transformer coupling via transformers 310 and 350 is operative in passing respective bi-directional Ethernet data packet signals while providing adequate DC isolation for electrical safety purpose as specified in the IEEE 820.3 standard. Furthermore, according to the invention, each of the 4 cable-side center taps 315 of the transformer 310 is connected to each of the 4 corresponding cable-side center taps 355 of the transformer 350 so as to establish a bypass circuit for passing PoE inline power from the RJ45 jack 202 to the Rj45 jack 204, and vice versa. As a result, when the RJ45 jack 202 is connected to an uplink cable that carries both data packet signals and PoE inline power, the PoE inline power will be passed from the RJ45 jack 202 to the RJ45 jack 204 so that a PoE compatible network device connected to the RJ45 jack 204 can receive the PoE inline power presented on the uplink cable connection.

According to the invention, the transformers 310 and 350 are PoE compatible that are operative in passing respective full duplex Ethernet data packet signals without being affected by even the highest level of current flow of the PoE inline power through the respective connected center taps of the transformers 310 and 350. The maximum magnitude of the PoE current flow is limited to 350 mA in accordance with the IEEE 802.3af standard or 720 mA in accordance with the IEEE 802.3 at standard (also referred to as PoE+), which should be used as guidelines for selecting correctly rated transformers for the transformer module 270.

Two resettable fuses 320 and 325 may be further used in forming the two selected center tap connections between the transformers 310 and 350 as shown in FIG. 3, for the purpose of over-current protection in case the PoE inline power becomes shorted for any reasons. The trip current at which the resettable fuse becomes triggered is selected to allow reliable passage of PoE inline power current at its maximum current level. When the resettable fuse 320 or 325 is triggered, it becomes high impedance that results in the disconnection of the corresponding PoE power pass-through circuit.

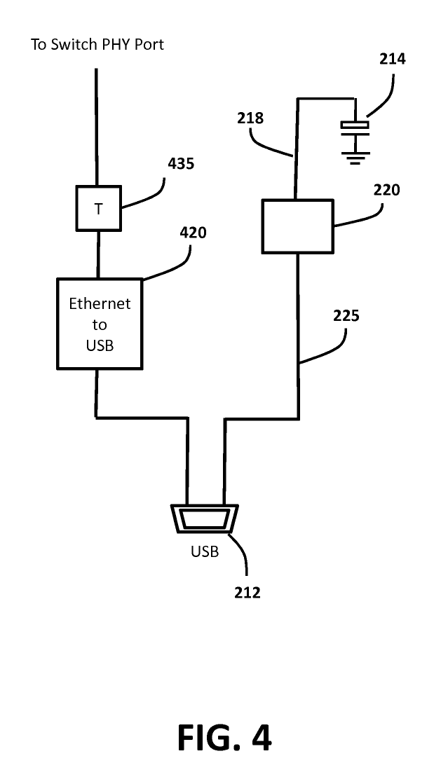

FIG. 4 is a block diagram of an embodiment of the invention in which the USB connector 212 shown in FIG. 2 is further used as a network port for the Ethernet switching ASIC 210 to send and receive full-duplex Ethernet data packets to and from a connected USB host device such as the computer 120 in FIG. 1. A USB to Ethernet adapter 420 is implemented with an USB interface and an Ethernet interface by which the USB interface is connected with two differential data pins of the USB connector 212 and the Ethernet interface is coupled with a selected PHY port of the Ethernet switching ASIC 210 via an Ethernet signal transformer 435. The USB to Ethernet adapter 420 is operative in converting bi-directional USB data packet signals associated with the USB connector 212 to full duplex Ethernet data packet signals associated with the selected PHY port of the Ethernet switching ASIC 210. Specifically, a USB2.0 to 10/100/1000M Gigabit Ethernet Controller, AX88178, from ASIX Electronics Corporation is used as the USB to Ethernet adapter 420. As such, the Ethernet switching ASIC 210 according to the invention can use the USB connector 212 as a network port to send and receive Ethernet data packets to and from a connected USB host device.

Although the present invention has been described in terms of various embodiments, it is to be understood that such disclosure is not to be interpreted as limiting. Various changes and modifications will no doubt become apparent to those skilled in the art after reading the above disclosure. Accordingly, it is intended that the appended claims be interpreted as covering all changes and modifications as fall within the true spirit and scope of the invention. As a result, the invention is not limited to the specific examples and illustrations discussed above, but only the following claims and their equivalents.

What is claimed is:

1. A data packet switching system capable of providing data packet traffic visibility, comprising:
an Ethernet switch, the Ethernet switch having a plurality of network ports including a target port and a monitor port, the Ethernet switch being operative in receiving a data packet and forwarding the data packet to at least one selected network port according to the destination MAC address of the data packet, wherein the Ethernet switch is configured upon power-on reset to forward a copy of data packets of the target port to the monitor port.

2. The data packet switching system of claim 1, wherein a copy of incoming data packets of the target port is forwarded to the monitor port and a copy of the outgoing data packets of the target port is forwarded to a second monitor port selected from the plurality of network ports.

3. The data packet switching system of claim 1, wherein the Ethernet switch further includes a power coupling circuit operative in passing Power over Ethernet (PoE) inline power between the target port and a network port selected from the plurality of the network ports.

4. The data packet switching system of claim 3, wherein the Ethernet further includes an over-current protection component operative to disconnect the power coupling circuit upon detection of over-current events related to the PoE inline power.

5. The data packet switching system of claim 1, wherein the Ethernet switch further includes a USB port connectable to a USB host device for receiving power from the USB host device, wherein the USB port is configured to suppress inrush current.

6. The data packet switching system of claim 5, wherein the total power consumption of the Ethernet switch is limited to less than the maximum output power available from the USB host device.

7. The data packet switching system of claim 5, wherein the Ethernet switch further includes a USB to Ethernet adapter having a USB interface and an Ethernet interface, the USB to Ethernet adapter being operative in converting full duplex Ethernet data packets associated with the Ethernet interface to bi-directional USB data packets associated with the USB interface.

8. An Ethernet switch, comprising:
An Ethernet switching module, the Ethernet switching module being coupled with a plurality of network ports including a target port and a monitor port, each network port being operative in receiving a data packet and forwarding the data packet to at least one selected network port according to the destination MAC address of the data packet; and
a memory device, the memory device being coupled with the Ethernet switching module for storing and loading port mirroring related configuration data to the Ethernet switching module upon power-on reset, wherein the Ethernet switching module is configured to forward a copy of data packets of the target port to the monitor port.

9. The Ethernet switch of claim 8, wherein the Ethernet switch is unmanaged, not externally configurable by a user.

10. The Ethernet switch of claim 8, wherein a copy of incoming data packets of the target port is forwarded to the monitor port and a copy of the outgoing data packets of the target port is forwarded to a second monitor port selected from the plurality of network ports.

11. The Ethernet switch of claim 8, further comprising a power coupling circuit operative in passing Power over Ethernet (PoE) inline power between the target port and a network port selected from the plurality of the network ports.

12. The Ethernet switch of claim 11, further comprising an over-current protection component operative to disconnect the power coupling circuit upon detection of over-current events related to the PoE inline power.

13. The Ethernet switch of claim 8, further comprising a USB port connectable to a USB host device for receiving power from the USB host device, wherein the USB port is configured to suppress inrush current.

14. The Ethernet switch of claim 13, wherein the total power consumption of the Ethernet switch is limited to less than the maximum output power available from the USB host device.

15. The Ethernet switch of claim 13, further comprising a USB to Ethernet adapter having a USB interface and an Ethernet interface, the USB to Ethernet adapter being operative in converting full duplex Ethernet data packets associated with the Ethernet interface to bi-directional USB data packets associated with the USB interface.

16. An Ethernet switch having a plurality of network ports, each network port being operative in receiving a data packet and forwarding the data packet to at least one selected network port according to the destination MAC address of the data packet, comprising:
a power coupling circuit, the power coupling circuit being operative to pass Power over Ethernet (PoE) inline power from a first network port selected from the plurality of network ports to a second network port selected from the plurality of network ports; and
an over-current protection component, the over-current protection component being operative to disconnect the power coupling circuit upon detection of over-current events related to the PoE inline power.

17. The Ethernet switch of claim 16, further comprising a monitor port selected from the plurality of network ports, wherein the monitor port is configured to receive a copy of data packets of the first network port.

18. The Ethernet switch of claim 16, wherein a copy of incoming data packets of the first network port is forwarded to the monitor port and a copy of the outgoing data packets of the first network port is forwarded to a second monitor port selected from the plurality of network ports.

19. The Ethernet switch of claim 16, further comprising a USB port connectable to a USB host device for receiving power from the USB host device, wherein the USB port is configured to suppress the occurring of inrush current.

20. The Ethernet switch of claim 19, wherein the total power consumption of the Ethernet switch is limited to less than the maximum output power available from the USB host device.

21. The Ethernet switch of claim 19, further comprising a USB to Ethernet adapter having a USB interface and an Ethernet interface, the USB to Ethernet adapter being operative in converting full duplex Ethernet data packets associated with the Ethernet interface to bi-directional USB data packets associated with the USB interface.
